(19) United States
(12) Patent Application Publication
(10) Pub. No.: US 2025/0196870 A1
(43) Pub. Date: Jun. 19, 2025

(54) UPDATING MODE PARAMETERS OF A DRIVING MODE BASED ON A LEARNABLE DRIVING PROFILE

(71) Applicant: Honda Motor Co., Ltd., Tokyo (JP)

(72) Inventors: DYLAN J MYERS, Marysville, OH (US); CASEY D. MYERS, Marysville, OH (US); NICHOLAS TODD HEYDINGER, Dublin, OH (US); NATHAN B. KIMBLE, Raymond, OH (US)

(21) Appl. No.: 18/541,740

(22) Filed: Dec. 15, 2023

(51) Int. Cl. B60W 50/08; B60W 30/02; B60W 30/18; B60W 50/14; B60W 60/00

(52) U.S. Cl. CPC B60W 50/082; B60W 30/18127; B60W 50/14; B60W 60/005; B60W 30/02; B60W 2050/146; B60W 2510/18; B60W 2510/22; B60W 2540/10; B60W 2540/18; B60W 2540/30; B60W 2552/05; B60W 2554/00; B60W 2555/20; B60W 2556/10; B60W 2710/18; B60W 2710/20; B60W 2710/30; B60W 2720/106

(57) ABSTRACT

A system for a vehicle is provided for updating mode parameters of a driving mode of a vehicle. The system includes a control circuitry to receive sensor information comprising operational parameters associated with the vehicle and ambient information associated with an environment outside the vehicle. Based on the sensor information, the control circuitry determines a driving profile associated with a user of the vehicle and selects a driving mode associated with the vehicle to update values of mode parameters associated with the selected driving mode. Further, the control circuitry controls a plurality of functional components of the vehicle based on the updated values, via at least one electronic control unit (ECU) of the vehicle.

### BACKGROUND

Integrated dynamic systems (IDS) offer users valuable insights into various vehicle parameters, including engine speed, suspension, and steering. However, these systems often come with inherent limitations when it comes to altering the driving experience. While users can adjust predefined modes to suit specific driving scenarios, these modes are typically constrained by their understanding of vehicle dynamics. IDS systems provide convenience through preset driving modes such as comfort, sport, and normal. However, while these modes often make comprehensive adjustments to vehicle parameters, the adjustments are often pre-determined and provide no room for fine-tuned customization. This limitation may be frustrating for drivers who seek a more personalized driving experience. Striking the right balance between user-friendly presets and advanced customization continues to be a challenge in the automotive industry, with driving enthusiasts craving greater control over their vehicle's behavior.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a system for a vehicle may be provided for updating mode parameters of a driving mode of the vehicle. The system may include a control circuitry which may be configured to receive sensor information which may include operational parameters associated with the vehicle and ambient information associated with an environment outside the vehicle. Based on the sensor information, the control circuitry may determine a driving profile associated with a user of the vehicle. The control circuitry may select a driving mode associated with the vehicle and may update values of mode parameters associated with the selected driving mode based on the driving profile. Further, the control circuitry may control a plurality of functional components of the vehicle based on the updated values, via at least one electronic control unit (ECU) of the vehicle.

According to another embodiment of the disclosure, a method including a system associated with a vehicle may be provided for updating mode parameter of a driving mode of the vehicle. The method may include receiving sensor information which may include operational parameters associated with the vehicle and ambient information associated with an environment outside the vehicle, and based on the sensor information, determining a driving profile associated with a user of the vehicle. The method may include selecting a driving mode associated with the vehicle and updating values of mode parameters associated with the selected driving mode based on the driving profile. Further, the method may include controlling a plurality of functional components of the vehicle based on the updated values, via at least one electronic control unit (ECU) of the vehicle.

According to another embodiment of the disclosure, a non-transitory computer-readable medium is provided. The non-transitory computer-readable medium may have stored thereon computer-implemented instructions that when executed by a system associated with a vehicle, cause the system to execute operations. The operations may include receiving sensor information comprising operational parameters associated with the vehicle and ambient information associated with an environment outside the vehicle and based on the sensor information, determining a driving profile associated with a user of the vehicle. The operations may further include selecting a driving mode associated with the vehicle and updating values of mode parameters associated with the selected driving mode based on the driving profile. Further, the operations may include controlling a plurality of functional components of the vehicle based on the updated values, via at least one electronic control unit (ECU) of the vehicle.

### BRIEF DESCRIPTION OF THE DRAWINGS

FIG. 1 is a diagram that illustrates an exemplary environment for updating values of mode parameters of a driving mode of a vehicle, in accordance with an embodiment of the disclosure.

FIG. 2 is a block diagram that illustrates an exemplary vehicle system for updating values of mode parameters of a driving mode based on a learnable driving profile of the vehicle, in accordance with an embodiment of the disclosure.

FIG. 3 is a block diagram that illustrates an exemplary sequence of operations to update values of mode parameters of a driving mode of a vehicle, in accordance with an embodiment of the disclosure.

FIGS. 4A and 4B are diagrams that collectively illustrate a graphic user interface (GUI) of a display device associated with a vehicle, in accordance with an embodiment of the disclosure.

FIG. 5 is an exemplary scenario diagram that illustrates a change from a preset driving mode to a smart driving mode, in accordance with an embodiment of the disclosure.

FIG. 6 is an exemplary scenario diagram that illustrates an update in mode parameters in a smart driving mode at different time instants, in accordance with an embodiment of the disclosure.

FIGS. 7A and 7B are diagrams that collectively illustrate an exemplary scenario for updating values of mode parameters based on a winding road condition, in accordance with an embodiment of the disclosure.

FIGS. 8A and 8B are diagrams that collectively illustrate an exemplary scenario for updating values of mode parameters based on a steady drive condition, in accordance with an embodiment of the disclosure.

FIG. 9 is a flowchart that illustrates an exemplary method of updating values of mode parameters of a driving mode of a vehicle, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a system for a vehicle. The disclosed system includes control circuitry which may be configured to receive sensor information that may capture operational parameters associated with the vehicle. The operational parameters may be indicative of driving style (for example, a level of braking, an acceleration pattern, a steering angle, a suspension feel, and the like.) associated with a user (i.e., a driver/occupant of the vehicle). The sensor information may further capture ambient information associated with an environment outside the vehicle. The ambient information may be indicative of external factors (for example, weather, road condition, terrain type, and the like) affecting the movement of the vehicle. Based on the sensor information, the control circuitry may determine a driving profile associated with the user and may select a driving mode associated with the vehicle, to update values of mode parameters associated with the selected driving mode. Thereafter, the control circuitry may control a plurality of functional components (for example, an acceleration pedal, a brake pedal, a suspension system, and the like) of the vehicle, based on the updated values of mode parameters, via at least one electronic control unit (ECU) of the vehicle.

Traditionally, when an in-vehicle integrated dynamic system (IDS) switches from one driving mode to another, as selected by the user (for example, the user switches from SPORT mode to a COMFORT mode), the full set of mode parameters is modified. For example, if the user is driving the car on a long highway, the user may select COMFORT mode. Thereafter, the IDS may alter mode parameter values that are appropriate for the comfort mode. Each of the mode parameters, including but not limited to acceleration, steering, suspension, and regenerative braking, may be changed in the comfort mode. Similarly, by setting the values of all mode parameters to a range acceptable for other preset modes, the IDS may move to additional preset modes. In contrast, the proposed system determines, in near real time, values for the mode parameters based on a user's driving style and influence of an environmental condition (learned from the sensor information), or a combination thereof. For example, the proposed system may learn the user's driving style to identify that the user is attempting to accelerate more often than expected while driving in the comfort mode. The proposed system, while in SMART Mode, will adjust the value of the acceleration response to correspond with SPORT Mode. With the update, the other mode parameters (such steering, suspension, or regenerative braking) may still be in the comfort mode, but the system allows for a more sensitive acceleration pedal (as in the sport mode). As another example, the proposed system may suggest a value of adjustment for a steering angle in the comfort mode, which may assist the user to steer an electric power steering system with better feel in a slippery road condition, while keeping the other mode parameters (for example, acceleration, suspension, or regenerative braking) in the normal mode. Even if the user is unable to define the desired driving style, the system quickly learns the style and adapts to provide the desired driving experience by dynamically adjusting the values of the mode parameters (in close to real-time) and controlling different functional components of the vehicle real-time or near real-time.

Reference will now be made in detail to specific aspects or features, examples of which are illustrated in the accompanying drawings. Wherever possible, corresponding, or similar reference numbers will be used throughout the drawings to refer to the same or corresponding parts.

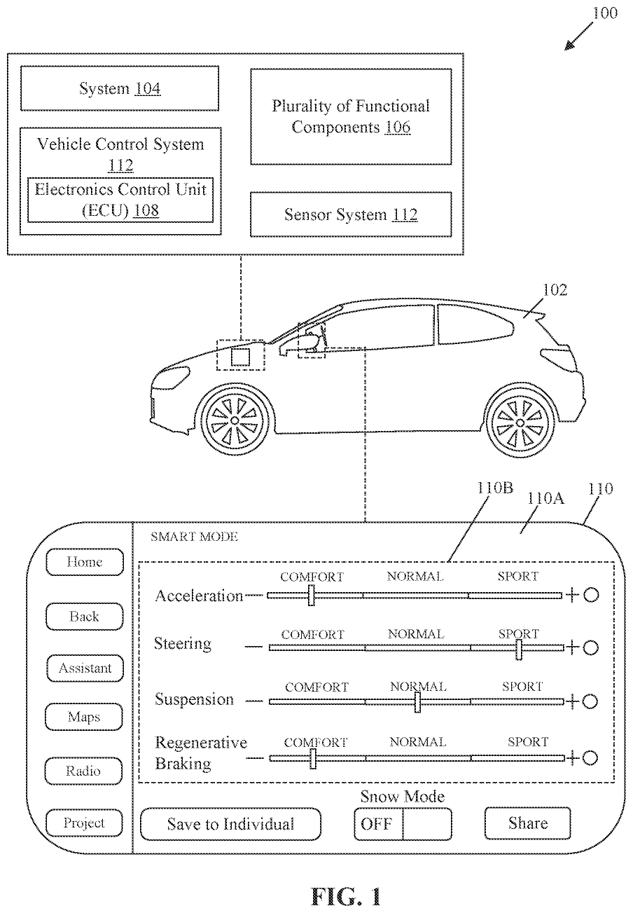

FIG. 1 is a diagram that illustrates an exemplary environment for updating values of mode parameters of a driving mode of a vehicle, in accordance with an embodiment of the disclosure. With reference to the FIG. 1, there is shown a diagram that includes an environment 100. The environment 100 may include a vehicle 102 and a system 104 that is communicatively coupled to a plurality of functional components 106 of the vehicle 102 and an electronic control unit (ECU) 108 of the vehicle 102. There is further shown a display device 110 that is integrated into the vehicle 102. The display device 110 includes a Graphical User Interface (GUI) 110A that displays values of mode parameters 110B associated with an active drive mode. The environment 100 may further include a sensor system 112 and a vehicle control system 114.

The vehicle 102 may be a non-autonomous vehicle, a semi-autonomous vehicle, or a fully autonomous vehicle, for example, as defined by National Highway Traffic Safety Administration (NHTSA). Examples of the vehicle 102 may include, but are not limited to, a two-wheeled vehicle, a three-wheeled vehicle, a four-wheeled vehicle, a hybrid vehicle, or a vehicle with autonomous drive capability that uses one or more distinct renewable or non-renewable power sources. The vehicle may use renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. It should be noted here that the vehicle 102 shown in FIG. 1 is a four-wheeled vehicle, which is merely an example. The present disclosure may be applicable to other types of vehicles (for example, trucks, buses, bikes, and the like). The description of such types of the vehicle 102 has been omitted from the disclosure for the sake of brevity.

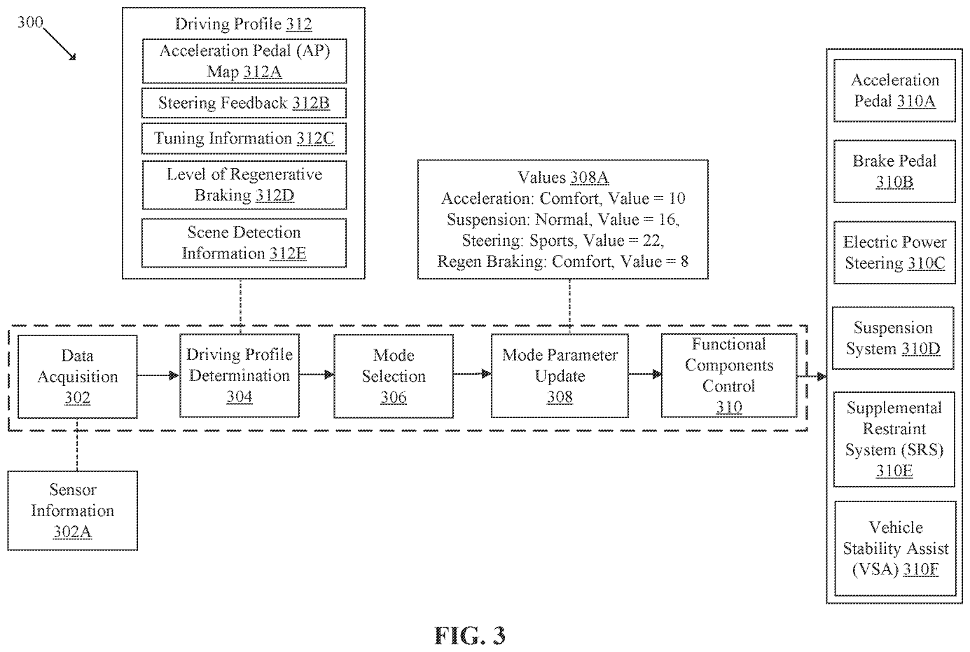

The plurality of functional components 106 may include, but is not limited to, an acceleration pedal, a brake pedal, an electric power steering, and a suspension system, for example. The functional components 106 may further include a supplemental restraint system (SRS) and a vehicle stability assist (VSA) system. The SRS (shown in FIG. 3) may be realized through several known safety technologies, such as a seat belt or an air bag. The VSA may comprise an Electronic Stability Control (ESC) system that may help to stabilize the vehicle 102 while the vehicle 102 is cornering and the movement of the vehicle 102 around a turn may become unsettled. The VSA may include a plurality of sensors (not shown) to monitor conditions associated with the road and a control mechanism to help reduce the possibility of skidding, plowing, or other loss-of-traction events. The VSA may improve the user's driving experience by enhancing control and stability of the vehicle 102 during acceleration, braking, or cornering of the vehicle 102. In some situations, the VSA may reduce throttle and brake individual wheels of the vehicle 102 to help restore the vehicle's balance on the road.

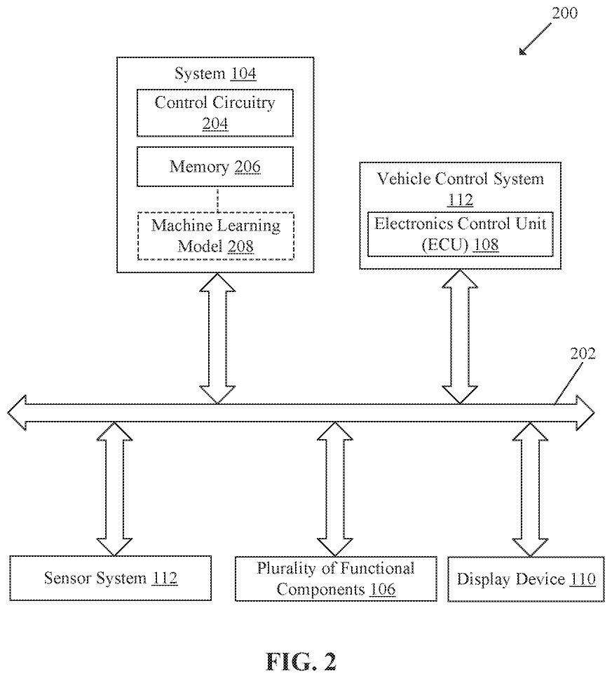

The plurality of functional components 106 may be controlled by the ECU 108, which may be linked with each of the functional components 106 and the vehicle control system 114 through an in-vehicle network (shown in FIG. 2). The ECU 108 may include suitable logic, circuitry, interfaces, and/or code that may be configured to control operation of the plurality of functional components 106. The ECU 108 may be a specialized electronic circuitry that may include an ECU processor to control different functions, such as, but not limited to, engine operations, tuning suspension system, regulating pressure of the master cylinder of brake, communication operations, and data acquisition associated with the sensor system 112 of the vehicle 102. In at least one embodiment, the ECU 108 may be further configured to control actuation of safety systems, such as, but not limited to, SRS and VSA.

The display device 110 may be communicatively coupled with the functional components 106 and the sensor system 112. The display device 110 may include suitable logic, circuitry, and interfaces that may be configured to display sensor information associated with the vehicle 102 and ambient information 114B associated with an environment outside the vehicle 102. The display device 110 may be realized through several known technologies, such as but not limited to, a Liquid Crystal Display (LCD) display, a Light Emitting Diode (LED) display, a plasma display, or an Organic LED (OLED) display technology. In accordance with an embodiment, the display device 110 may refer to a display screen of a head mounted device (HMD), a smart-glass device, a see-through display, a projection-based display, an electro-chromic display, or a transparent display.

The sensor system 112 may include a plurality of sensors (not shown) in the vehicle 102 to acquire sensor information. The sensor information may include operational parameters associated with the vehicle 102. For example, the operational parameters may include an acceleration pedal (AP) position associated with the acceleration pedal 310A of the vehicle 102, a master cylinder pressure associated with the brake pedal 310B of the vehicle 102, a steering angle associated with the electric power steering 310C of the vehicle 102, a plurality of suspension parameters associated with the suspension system 310D of the vehicle 102, and the like.

The sensor system 112 may further include a camera (not shown) which may be installed on at least one of: a front end or a rear end of the vehicle 102. The camera may include suitable logic, circuitry, or interfaces, that may be configured to capture images from multiple viewpoints to cover a 360-degree view of the surroundings of the vehicle 102. In accordance with an embodiment, the camera may further include a plurality of image sensors (not shown) to capture the 360-degree view of the surroundings of the vehicle 102. Examples of the camera may include, but are not limited to, an omnidirectional camera, a panoramic camera, an action camera, a wide-angle camera, a closed-circuit television (CCTV) camera, and/or other image capturing devices with image sensing capability. In an example embodiment, the camera may capture images of the environment 100 outside the vehicle 102 and such images may be used to detect a road condition, a type of road, a weather condition, a traffic condition, a terrain type, and the like on an active route. In accordance with an embodiment, the sensor system 112 may further include a rain sensor (not shown), which may be utilized to determine a level of precipitation in the environment outside the vehicle 102.

The sensor system 112 may further include a location sensor (not shown), which may include suitable logic, circuitry, and/or interfaces that may be configured to determine a current geo-location of the vehicle 102. Examples of the location sensor may include, but are not limited to, a Global Navigation Satellite System (GNSS)-based sensor, an Inertial Measurement Unit (IMU), or a combination thereof.

In accordance with an embodiment, the vehicle control system 114 may include the ECU 108. The vehicle control system 114 may include suitable logic, circuitry, interfaces, and/or code that may be configured to control operation of at least one of the functional components 106 via the ECU 108 of the vehicle 102. The vehicle control system 114 may be a specialized electronic circuitry that may control different functions, such as, but not limited to, engine operations, tuning suspension system, regulating pressure of the master cylinder of brake and actuation of the safety systems associated with the vehicle 102 (such as SRS and VSA).

In operation, the system 104 may be configured to receive the sensor information associated with the vehicle 102. The sensor information may be received from the sensor system 112 while the vehicle 102 is in a mobile state. Additionally, or alternatively, raw sensor information from the sensor system 112 may be processed using suitable data processing algorithms to extract the sensor information that is provided to the system 104. For example, images in the raw sensor information may be processed to extract scene information. The sensor information may include operational parameters associated with the vehicle 102. Each of the parameters may correspond to a functional component of the plurality of functional components 106. By way of example, and not limitation, the operational parameters may include an AP position associated with the acceleration pedal of the vehicle 102, a master cylinder pressure associated with the brake pedal, a steering angle of the electric power steering, and a plurality of suspension parameters of the suspension system associated with the vehicle 102.

The system 104 may be further configured to receive the ambient information, which may include, for example, the road condition, the type of road, the terrain type, the level of precipitation, the current geo-location of the vehicle 102 associated with the environment outside the vehicle 102. In one or more embodiments, the system 104 may be configured to apply a machine learning model 208 (shown in FIG. 2) on the sensor information to determine a driving profile 312 (shown in FIG. 3) associated with a user of the vehicle 102. Based on the driving profile, the system 104 may further select a driving mode associated with the vehicle 102. The driving mode may include mode parameters 110B (such as acceleration, steering, suspension, and a level of regenerative braking) associated with the plurality of functional components 106 of the vehicle 102. In an exemplary embodiment, the selected driving mode may be a dynamic mode or a smart mode that may allow the system 104 to update values of the individual mode parameters 110B based on the driving profile. In course of a journey, the update may be performed in real time or near real time as the driving profile is updated based on new datapoints included in the sensor information. In some driving conditions (e.g., winding road, snowy conditions, straight highway drive, and the like), the driving mode may be selected to be a preset mode (e.g., a comfort mode, a normal mode, or a sport mode) configured for the vehicle 102.

After the driving mode is selected, the system 104 may update values of the mode parameters 110B associated with the selected driving mode, based on the driving profile. Further, the system 104 may communicate the update with the one or more functional components 106, the display device 110, the sensor system 112, the ECU 108 and the vehicle control system 114 of the vehicle 102, via an in-vehicle network 202 (shown in FIG. 2). Based on the updated values of the mode parameters 110B, the system 104 may control, via the ECU 108, the plurality of functional components 106 of the vehicle 102.

FIG. 2 is a block diagram that illustrates an exemplary vehicle system for updating values of mode parameters of a driving mode based on a learnable driving profile of the vehicle, in accordance with an embodiment of the disclosure. FIG. 2 is explained in conjunction with elements from FIG. 1. With reference to the FIG. 2, there is shown a block diagram 200 of a vehicle system that includes an in-vehicle network 202, control circuitry 204, and a memory 206. The in-vehicle network 202 may be communicatively coupled to the vehicle control system 114, which may further include the ECU 108. In accordance with an embodiment, the system 104 may store a machine learning model 208 in the memory 206. Alternatively, the system 104 may include a computer-executable program, which when executed, may communicate with a server that that may store the machine learning model 208. The communication may be performed to utilize the machine learning model 208 for real time or near real time inference.

The in-vehicle network 202 may be communicatively coupled to the sensor system 112 and may enable transfer of the sensor information to different electronic components that may be connected to the in-vehicle network 202. The in-vehicle network 202 may include a medium through which the various control units, components, and/or systems (for example, the plurality of functional components 106, the ECU 108, the display device 110, the sensor system 112, the vehicle control system 114) of the vehicle 102 may communicate with each other. In accordance with an embodiment, the in-vehicle network 202 may exist in the vehicle 102 to connect various devices or components in the vehicle 102, in accordance with various wired and wireless communication protocols. Examples of the wired and wireless communication protocols for the in-vehicle network 202 may include, but are not limited to, a vehicle area network (VAN), a CAN bus, Domestic Digital Bus (D2B), Time-Triggered Protocol (TTP), FlexRay, IEEE 1394, Carrier Sense Multiple Access With Collision Detection (CSMA/CD) based data communication protocol, Inter-Integrated Circuit (I2C), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fiber (POF), Power-line communication (PLC), Serial Peripheral Interface (SPI) bus, and/or Local Interconnect Network (LIN).

The in-vehicle network 202 may be linked with the sensor system 112, which may acquire the sensor information (shown in FIG. 3). The sensor information may be shared with the control circuitry 204 of the system 104 for further processing. The sensor information may include, for example, operational parameters associated with the vehicle 102 and the ambient information. Each of the operational parameters may correspond to a functional component of the plurality of functional components 106 of the vehicle 102. For example, a parameter such as AP position may correspond to an acceleration pedal of the vehicle 102. The ambient information may be associated with an environment outside of the vehicle 102.

The control circuitry 204 may include suitable logic, circuitry, and/or interfaces code that may be configured to execute program instructions associated with different operations to be executed by the system 104. The control circuitry 204 may include one or more specialized processing units. In an embodiment, such specialized processing units may be implemented as an integrated processor or a cluster of processors that perform the functions of the one or more specialized processing units, collectively. For example, the control circuitry 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or process data. Examples of the control circuitry 204 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 206 may include suitable logic, circuitry, interfaces, and/or code that may be configured to store the program instructions executable by the control circuitry 204. In at least one embodiment, the memory 206 may be configured to store the machine learning model 208, the sensor information, and other information, such as a user profile and historical mode settings. The memory 206 may be a persistent storage medium, a non-persistent storage medium, or a combination thereof. Example implementations of the memory 206 may include, but are not limited to, Random Access Memory (RAM), Read Only Memory (ROM), Hard Disk Drive (HDD), a Solid-State Drive (SSD), a CPU cache, and/or a Secure Digital (SD) card.

The machine learning model 208 may be a classifier model or a regression that may be trained to identify a relationship between inputs, such as features in a training dataset. For example, the machine learning model 208 may predict values of mode parameters associated with a selected driving mode of the vehicle 102 based on inputs (based on the sensor information). The machine learning model 208 may be defined by its hyper-parameters, for example, weights, cost function, input size, number of layers, and the like. After several epochs of the training on the feature information in the training dataset, the machine learning model 208 may be trained to output a prediction/classification result for a set of inputs. The prediction result may be indicative of a class label (in case of classification) or a continuous mode parameter value (in case of a regression task) for each input of the set of inputs (e.g., input features extracted from new/unseen instances).

The machine learning model 208 may include electronic data, which may be implemented as, for example, a software component of an application executable on the system 104. The machine learning model 208 may rely on libraries, external scripts, or other logic/instructions for execution by a processing device, such as the control circuitry 204. The machine learning model 208 may utilize code and routines configured to enable a computing device to perform one or more operations. Additionally, or alternatively, the machine learning model 208 may be implemented using hardware including a processor, a microprocessor (e.g., to perform or control performance of one or more operations), a field-programmable gate array (FPGA), or an application-specific integrated circuit (ASIC). Alternatively, in some embodiments, the machine learning model 208 may be implemented using a combination of hardware and software. Examples of the machine learning model 208 may include, but are not limited to, a Multilayer Perceptron (MLP) regressor, a linear regression model, a logistic regression model, a random forest model, an artificial neural network, and a decision tree.

The functions or operations executed by the system 104, as described in FIG. 1, may be performed by the control circuitry 204. Operations executed by the control circuitry 204 are described in detail, for example, in FIGS. 3, 4A, 4B, 5, 6, 7A 7B, 8A, and 8B.

FIG. 3 is a block diagram that illustrates an exemplary sequence of operations to update values of mode parameters of a driving mode of a vehicle, in accordance with an embodiment of the disclosure. FIG. 3 is explained in conjunction with elements from FIG. 1 and FIG. 2. With reference to FIG. 3, there is shown a block diagram 300 that includes a sequence of operations from 302 to 310.

At 302, data acquisition may be performed. The system 104 may receive sensor information 302A that includes the operational parameters associated with the vehicle 102 and the ambient information associated with an environment outside the vehicle 102. The data acquisition 302 may be performed via the sensor system 112 that may include a plurality of sensors (not shown) integrated into the plurality of functional components 106 of the vehicle 102 and/or other non-functional components (e.g., chassis) of the vehicle 102. Each of the operational parameters may corresponds to a functional component of the plurality of functional components 106 of the vehicle 102. Example of the operational parameters associated with the vehicle 102 may include, but is not limited to, an AP position of the vehicle 102, a master cylinder pressure associated with a brake pedal of the vehicle 102, a steering angle associated with an electric power steering of the vehicle 102, and a plurality of suspension parameters associated with a suspension system of the vehicle 102.

The ambient information may include, for example, a condition of a road in an active route of the vehicle 102, a terrain type associated with the active route, an amount of precipitation on the road, a type of the road, a weather condition for a current location of the vehicle 102 in the active route.

At 304, a driving profile 312 may be determined. The system 104 may be configured to determine the driving profile 312 associated with the user of the vehicle 102, based on the sensor information 302A. Specifically, the driving profile 312 may include a mapping between input features (based on the operational parameters and the ambient information) and output variables such as the individual mode parameters associated with a driving mode (e.g., a smart mode) of the vehicle 102. Such mode parameters be used to may control the operation of the plurality of functional components 106 of the vehicle 102.

In accordance with an embodiment, the system 104 may learn the driving profile 312 by processing the sensor information 302A using a pre-trained machine learning model. Specifically, the system 104 may be configured to apply the pre-trained machine learning model (such as the machine learning model 208) on the sensor information 302A to determine the driving profile 312 associated with the user (e.g., the driver) of the vehicle 102.

In accordance with an embodiment, the system 104 may be further configured to acquire historical sensor data (not shown) associated with the vehicle 102, and the acquired data may be stored in the memory 206. The historical sensor data may include historical data points related to the operational parameters associated with the vehicle 102 and the ambient information associated with the environment around the vehicle 102. The system 104 may apply the machine learning model 208 on the historical sensor data to further determine the driving profile 312.

The driving profile 312 may include, for example, an AP map 312A associated with an AP component of the vehicle 102, a steering feedback 312B associated with a steering component of the vehicle 102, tuning information 312C associated with a suspension component of the vehicle 102, a level of regenerative braking 312D associated with a braking component of the vehicle 102, scene detection information 312E associated with the environment outside the vehicle 102.

The AP map 312A may indicate a desired output of a powertrain at a current speed value. The sensor system 112 may collect the acceleration pedal position data and a speed detection sensor (not shown) associated with the sensor system 112 may determine a speed of the vehicle 102. The AP map 312A may also indicate an amount of adjustment that may be required for an acceleration pedal 310A in accordance with the current speed of the vehicle 102. Typically, the user may depress the acceleration pedal 310A, which may indicate a desired adjustment of the acceleration pedal 310A required to maintain the speed of the vehicle 102 at the current value.

The steering feedback 312B may indicate a desired or an optimum steering angle that is to be maintained for a smooth steering of the vehicle 102. The sensor system 112 may collect a steering angle associated with the electric power steering 310C of the vehicle 102 and an angle sensor (not shown) associated with the sensor system 112 may determine a rotational effort or torque that the user applies to the steering wheel. The steering feedback 312B shows a value of adjustment for the steering angle in accordance with the rotational effort or torque applied by the user (as detected by the sensor system 112). The electric power steering 310C may include an electric motor which may be placed on a steering column of the electric power steering 310C. The electric motor may receive command from the ECU 108 regarding the value of adjustment in the steering angle to assist the user to steer the electric power steering 310C to a desired or optimum steering angle.

The tuning information 312C may indicate a desired or an optimum adjustment of the damping force of the suspension system 310D. The sensor system 112 may measure a value of damping force experienced by the suspension system 310D of the vehicle 102. The tuning information 312C shows an amount of adjustment in the damping force, in accordance with current speed, acceleration, and braking of the vehicle 102 (as detected by the sensor system 112). The tuning information 312C may be used to adjust a speed of compression or rebound of a spring, such as, but not limited to, a spiral spring, a leaf spring, or a coil spring associated with the suspension system 310D.

In an exemplary embodiment, the suspension system 310D may include an air suspension, which may include alteration of stiffness of the spring by adjusting the effective volume of the spring associated with the suspension system 310D. The adjustment of the effective volume of the spring may be achieved via a solenoid valve to connect the spring to an extra volume (for example, an accumulator). Further, the extra volumes may allow the spring rate to be altered based on the ambient information, which may correspond to the road condition. In order to stiffen the spring while the vehicle 102 may be cruising at a higher speed, the solenoid may disconnect the extra volume. In case a softer spring rate is required based on the road condition, the solenoid may connect the extra volume.

The level of regenerative braking 312D may represent the intended or ideal amount of braking that the driver can implement using the brake pedal 310B or deceleration of the vehicle 102 that may be caused due to a level of adjustment of the acceleration pedal 310A. Depending on the user's driving profile, the level of regenerative braking 312D may be modified. The level of regenerative braking 312D may indicate a level of braking that needs to be adjusted depending on the vehicle's acceleration, current speed, and/or the state of the road. The level of regenerative braking 312D in one example embodiment may be at least one of low, moderate, and standard. The vehicle 102 may brake less and may be preferred for an open or empty road if the level of regenerative braking 312D is lower; conversely, if the level of regenerative braking 312D is higher and the road has heavy traffic, the vehicle 102 may brake more and may be preferred for that situation.

The scene detection information 312E may indicate environmental conditions, such as, but not limited to, objects in the active route of the vehicle 102, at least one pothole on the road, an impact generated on the vehicle 102, a road condition, a terrain type, or a weather condition. The system 104 may apply adjustments to at least one of the plurality of functional components 106 while the sensor system 112 collects the ambient information. In an exemplary embodiment, the sensor system 112 may include a plurality of sensors (not shown) which may be configured to measure any physical impact on the vehicle 102. Based on a level of the measured impact experienced by the vehicle 102, the ECU 108 may activate the SRS 310E (such as airbag(s)).

In accordance with an embodiment, a plurality of sensors in the sensor system 112 may be configured to monitor parameters or events that may contribute to skidding, plowing and other loss-of-traction events. The ECU 108 may activate the VSA 310F to improve the user's driving experience by enhancing control and stability of the vehicle 102 during acceleration, braking or cornering of the vehicle 102. The VSA 310F may reduce throttle and brake individual wheels of the vehicle 102 to help restore the movement of the vehicle 102 along an intended path.

At 306, a mode selection may be performed. At any time-instant, the user or the system 104 may select a driving mode associated with the vehicle 102. The selected driving mode may be referred to as a smart mode. The smart mode may allow the system 104 to dynamically update values of various mode parameters associated with the selected driving mode based on the driving profile 312. Such parameters may be related to acceleration, steering, suspension, regenerative braking, safety, and the like.

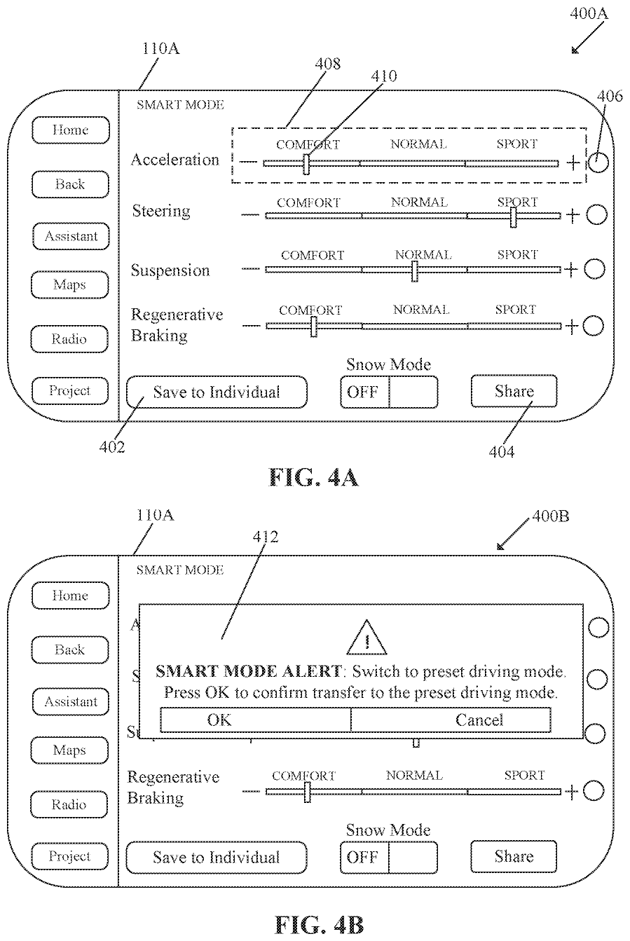

At 308, values of the mode parameters may be updated. Once the driving mode (i.e., the smart mode) is selected, the system 104 may update the values of the mode parameters associated with the selected driving mode. The update may be performed based on the driving profile 312. As an example, the values of the mode parameters may be updated so that the value of acceleration is 10 in a comfort mode, the value of suspension in the normal mode is 16, the value of steering in the sport mode is 22, and the value of the level of regenerative braking in the comfort mode is 8 at a particular time instant. Other examples of the update are provided, for example, in FIGS. 4A, 4B, 5, 6, 7A,7B, 8A and 8B.

In accordance with an embodiment, the sensor system 112 may include sensors which may be configured to detect a cruise operation of the vehicle 102. The system 104 may be configured to detect an execution of the cruise control operation for a duration of a movement of the vehicle 102. Based on the detection, the update of the values of the mode parameters may be paused for the duration.

At 310, functional components may be controlled. The system 104 may be configured to control, via the ECU 108 of the vehicle 102, the plurality of functional components 106 of the vehicle 102 based on the updated values of the mode parameters. Even if the user is unable to define the desired driving experience, the vehicle 102 can quickly adapt to provide the desired driving experience by dynamically adjusting the values of the mode parameters (in close to real-time) and controlling the plurality of functional components 106 (in close to real-time).

In accordance with an embodiment, the display device 110 may include the GUI 110A that may be configured to render required information to a user (i.e., a driver/occupant of the vehicle). For example, the GUI 110A may render information regarding the selected driving mode and the updated values of the mode parameters.

FIGS. 4A and 4B are diagrams that collectively illustrate a graphic user interface (GUI) of a display device associated with a vehicle, in accordance with an embodiment of the disclosure. FIGS. 4A and 4B are explained in conjunction with elements from FIG. 1, FIG. 2, and FIG. 3. With reference to FIGS. 4A and 4B, there is shown a diagram 400 of the GUI 110A, which may be rendered on the display device 110 of the vehicle 102. The GUI 110A may display graphical elements that may correspond to user-selectable options for a view selection, a display control, and other interactive user-options. Additionally, the GUI 110A may render a selected driving mode, the mode parameters 110B associated with the selected driving mode, and the updated values of the mode parameters 110B.

The GUI 110A may include a first UI element 402, which may save updated values of the mode parameters 110B as an individual driving mode. In case a user feels comfortable with the updated values of the mode parameters 110B, the user may save the updated values as the individual driving mode by clicking on the first UI element 402. The GUI 110A may further include a second UI element 404, which may share the individual driving mode with a vehicle that may be associated with a person who is different from the user. For example, the user may share, via a platform, the individual driving mode with a friend's vehicle that supports custom driving modes. The platform may include one of a mail, a social media platform, a cloud server, a Vehicle-to-Vehicle (V2V) network, or a WAN network.

The GUI 110A may include a first option 406, which when selected, may lock at least one of the updated values of the mode parameters 110B. For example, the system 104 may receive a selection of the first option 406 and may ignore the update of at least one of the values of the mode parameters 110B based on the selection of the first option 406. In some instances, the first option 406 may be selected if the user is dissatisfied with the updated values of the mode parameters 110B and desires to lock some or all of the values of the mode parameters 110B. In some embodiments, the first option 406 may be automatically selected to lock the update of the values of the mode parameters 110B if the vehicle 102 is determined to be in a cruise mode or a snow mode.

The GUI 110A may include a slider UI element 408 for each of the mode parameters. Each segment of a length of the slider UI element 408 may represent a range of values associated with a type of mode for a corresponding mode parameter. In an exemplary embodiment, each segment may correspond to one of a comfort mode, a normal mode, or a sport mode. The slider UI element 408 may be indicative of the range of values of the mode parameters 110B. As shown, for example, the range for the comfort mode is lowest, the range for the sport mode is highest, and the range for the normal mode is between that of the comfort mode and the sport mode.

In accordance with an embodiment, the GUI 110A may further include an indicator 410, which may indicate the updated values of mode parameters 110B. The indicator 410 may move along the length of the slider UI element 408 as individual values of the mode parameters 110B are updated. Specifically, the update of each value of the mode parameters 110B may be followed by a movement of the indicator 410 along the slider UI element 408.

In accordance with an embodiment, the GUI 110A may include a prompt overlay 412, which may provide an option to switch to a preset driving mode that may be for a weather condition or a road traffic condition. In an embodiment, the system 104 may store the preset driving mode in the memory 206 and conditions to trigger the prompt overlay 412. At any time instant, the system 104 may receive the ambient information that may specify weather and road traffic conditions. If such conditions match the conditions stored in the memory 206 for the preset driving mode, the GUI 110A may display the prompt overlay 412. The system 104 may receive a selection of the option in the prompt overlay 412 and may select the preset driving mode based on the selection. After the selection of the preset driving mode, the system 104 may control the plurality of functional components 106 based on values of the mode parameters 110B associated with the preset driving mode. For example, the preset driving mode may be a snow mode for snowy conditions. A message may be rendered on the GUI 110A to indicate that the vehicle 102 is currently in the selected preset driving mode. While the preset mode (e.g., snow mode) is active, the updated values of the mode parameters 110B for the smart mode may not be used. If the vehicle 102 exits the preset driving mode, then the system 104 may switch to the updated values of the mode parameters 110B for the smart mode.

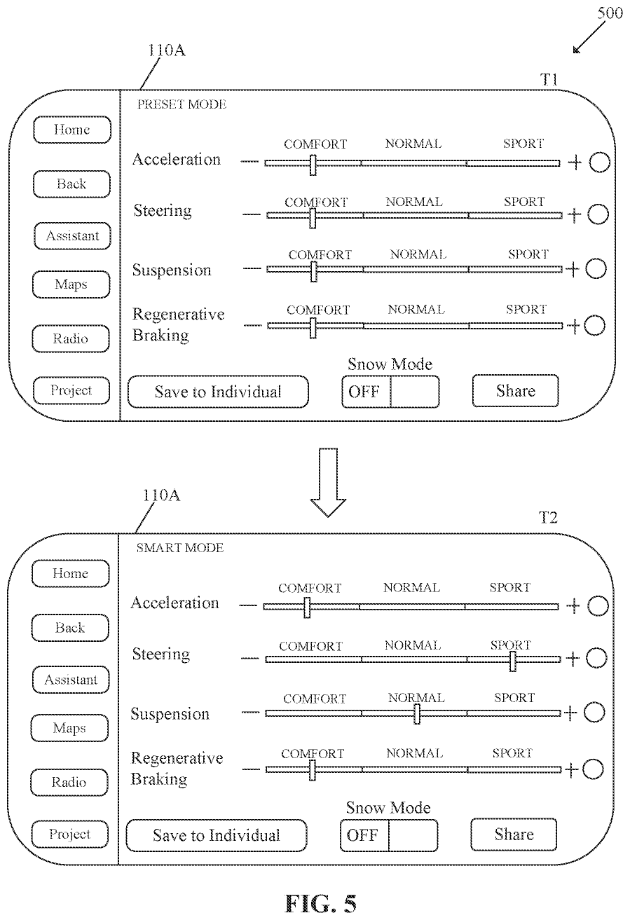

FIG. 5 is an exemplary scenario diagram that illustrates a change from a preset driving mode to a smart driving mode, in accordance with an embodiment of the disclosure. FIG. 5 is explained in conjunction with elements from FIG. 1, FIG. 2, FIG. 3, and FIGS. 4A and 4B. With reference to FIG. 5, there is shown a scenario diagram 500 that includes the GUI 110A at a time instant T1 and the GUI 110A at time instant T2.

At T1, an initial driving mode may be selected as a default or preset mode and values of the mode parameters may be adjusted to be in the range of the comfort mode.

At T2, the system 104 may receive the sensor information 302A. Based on the sensor information 302A, the system 104 may determine the driving profile 312 and may switch to a dynamic driving mode (also referred to as a smart mode). Based on the determined driving profile 312, the system 104 may update the values of the individual mode parameters. The update may be performed regularly or continuously in near real time while the vehicle 102 stays in the smart mode. The updated values of the mode parameters are depicted by new positions of the indicators. As an example, the value for steering may change from a value associated with the comfort mode to a value associated with the sport mode, while the value for suspension may change from a value associated with the comfort mode to a value associated with the normal mode.

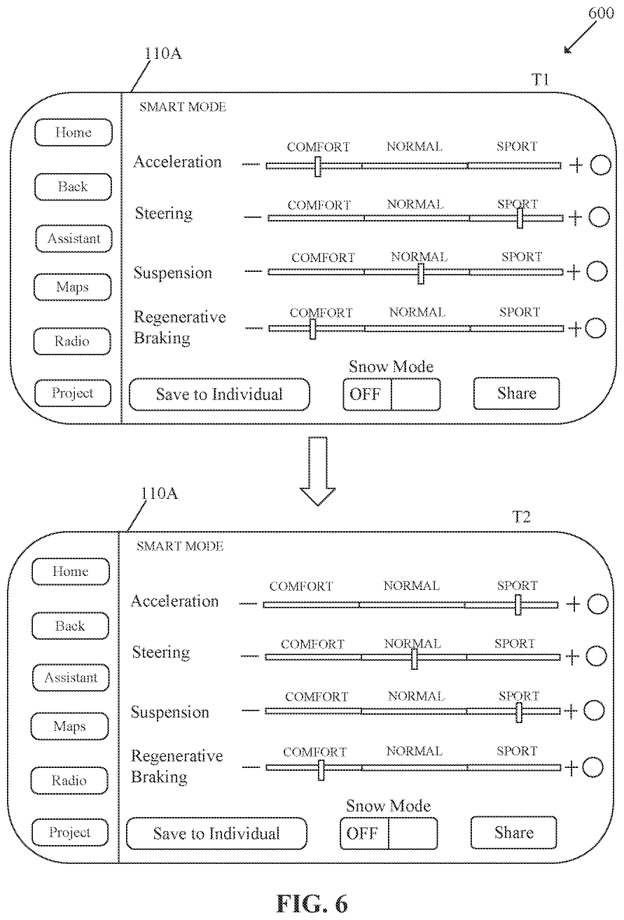

FIG. 6 is an exemplary scenario diagram that illustrates an update in mode parameters in a smart driving mode at different time instant, in accordance with an embodiment of the disclosure. FIG. 6 is explained in conjunction with elements from FIG. 1, FIG. 2, FIG. 3, FIGS. 4A and 4B, and FIG. 5. With reference to FIG. 6, there is shown a scenario diagram 600 that includes the GUI 110A at a time instant T1 and the GUI 110A at time instant T2. At T1, the vehicle 102 may be in the smart mode and the values of the mode parameters corresponding to the smart mode are shown.

At T2, the system 104 may receive the sensor information 302A and may update the driving profile 312 based on the received sensor information 302A. Based on the updated driving profile 312, the system 104 may further update the values of the mode parameters, as shown (at T2). The updated values of the mode parameters are depicted by new positions of the indicators. In an exemplary embodiment, the value for the acceleration may update from a value in the comfort mode to a value in the sport mode, the value for steering may update from a value in the sport mode to a value in the normal mode, the value for suspension may update from a value in the normal mode to a value in the sport mode, and the value of regenerative braking may update to a new value within the comfort mode (for example, the value at T1 may be 2 and at time T2 may be 8).

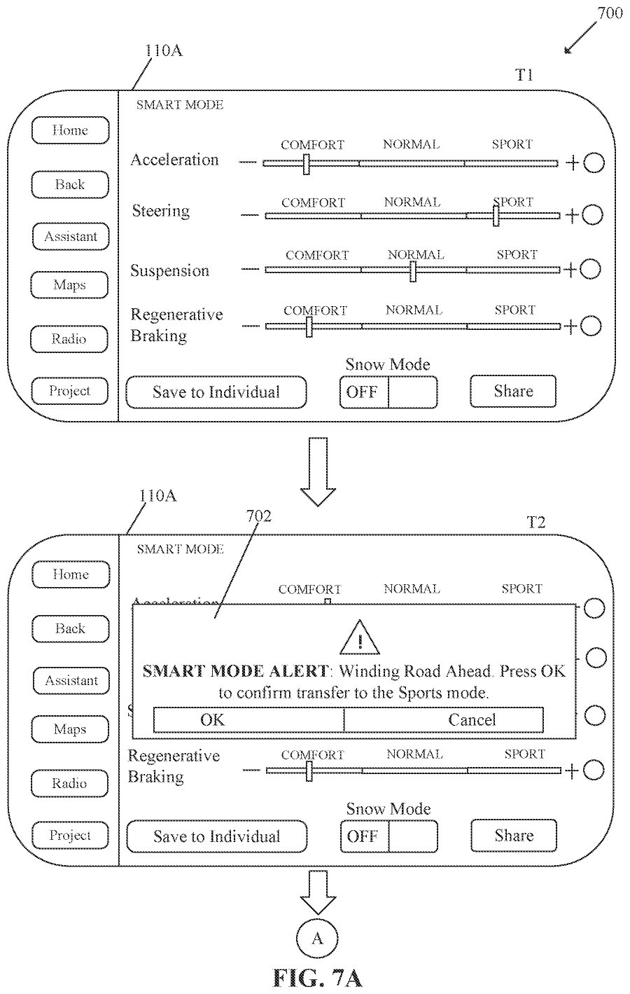

FIGS. 7A and 7B are diagrams that collectively illustrate an exemplary scenario for updating values of mode parameters based on a winding road condition, in accordance with an embodiment of the disclosure. FIGS. 7A and 7B are explained in conjunction with elements from FIG. 1, FIG. 2, FIG. 3, FIGS. 4A and 4B, FIG. 5, and FIG. 6. With reference to FIGS. 7A and 7B, there is shown an exemplary scenario 700 that includes the GUI 110A at a time instant T1, a GUI 110A with a prompt overlay 702 for a winding road condition at a time instant T2, and the GUI 110A at time instant T3.

At T1, values of mode parameters may be adjusted as per the smart mode. As shown, for example, the GUI 110A includes the slider for each mode parameter (i.e., acceleration, steering, suspension, and braking) which is within a specific range of values. In the smart mode, the system 104 may update individual mode parameters based on the driving profile. In some instances, the user may be allowed to make changes in the values of the individual mode parameters via one or more options in the GUI 110A.

At T2, the system 104 may detect a winding road condition based on the ambient information (e.g., road images). Based on the detection, the system 104 may display, on the GUI 110A, the prompt overlay 702 which provides an option to switch to a preset driving mode, such as the sport mode.

At T3, the system 104 may receive, via the GUI 110A, a selection of the option in the prompt overlay 702. Based on the selection, the preset driving mode (such as the sport mode) may be selected. The system 104 may further control the plurality of functional components 106 based on values of the mode parameters associated with the preset driving mode. When a particular mode such as the sport mode is active, the system 104 may not update individual mode parameters of the particular mode based on the driving profile. The updated values of the mode parameters are depicted by new positions of the indicators in the GUI 110A.

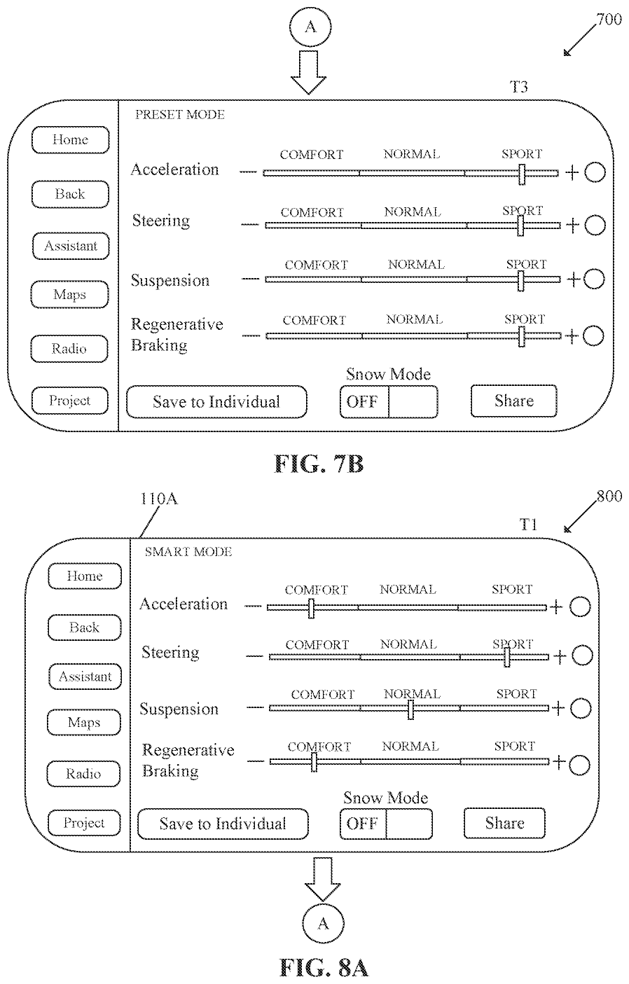

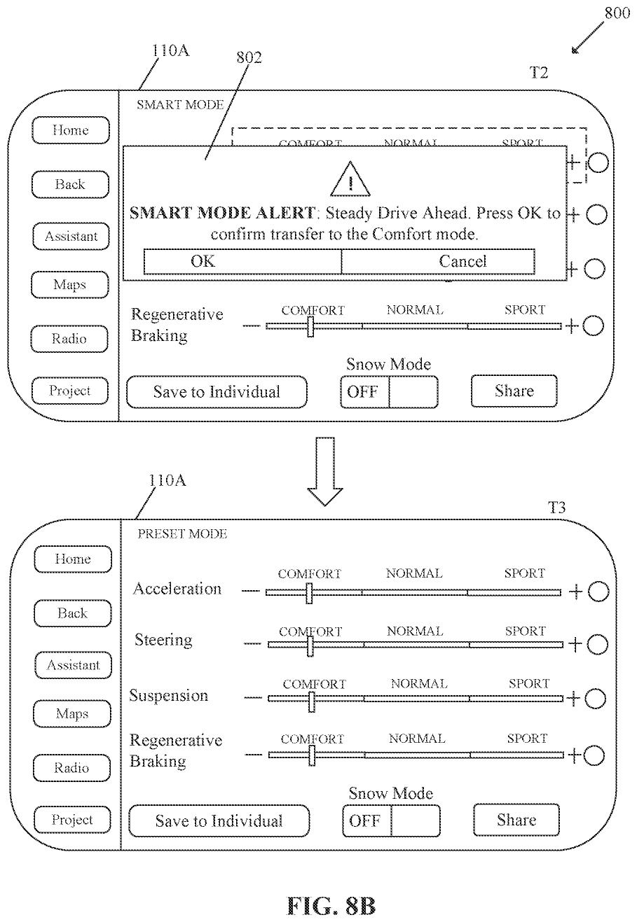

FIGS. 8A and 8B are diagrams that collectively illustrate an exemplary scenario for updating values of mode parameters based on a steady drive condition, in accordance with an embodiment of the disclosure. FIGS. 8A and 8B are explained in conjunction with elements from FIG. 1, FIG. 2, FIG. 3, FIGS. 4A and 4B, FIG. 5, FIG. 6, and FIGS. 7A and 7B. With reference to FIGS. 8A and 8B, there is shown an exemplary scenario 800 that includes the GUI 110A at a time instant T1, a GUI 110A with a prompt overlay 802 for a steady drive condition at a time instant T2, and the GUI 110A at a time instant T3.

At T1, values of mode parameters may be adjusted as per the smart mode. As shown, for example, the GUI 110A includes the slider for each mode parameter (i.e., acceleration, steering, suspension, and braking) which is within a specific range of values. In the smart mode, the system 104 may update individual mode parameters based on the driving profile. In some instances, the user may be allowed to make changes in the values of the individual mode parameters via one or more options in the GUI 110A.

At T2, the system 104 may detect a steady drive condition (e.g., a long highway) based on the ambient information (e.g., road images). Based on the detection, the system 104 may display, on the GUI 110A, the prompt overlay 802 which provides an option to switch to a preset driving mode, such as the comfort mode.

At T3, the system 104 may receive, via the GUI 110A, a selection of the option in the prompt overlay 802. Based on the selection, the preset driving mode (such as the comfort mode) may be selected. The system 104 may further control the plurality of functional components 106 based on values of the mode parameters associated with the preset driving mode. When a particular mode such as the comfort mode is active, the system 104 may not update individual mode parameters of the particular mode based on the driving profile. The updated values of the mode parameters are depicted by new positions of the indicators in the GUI 110A.

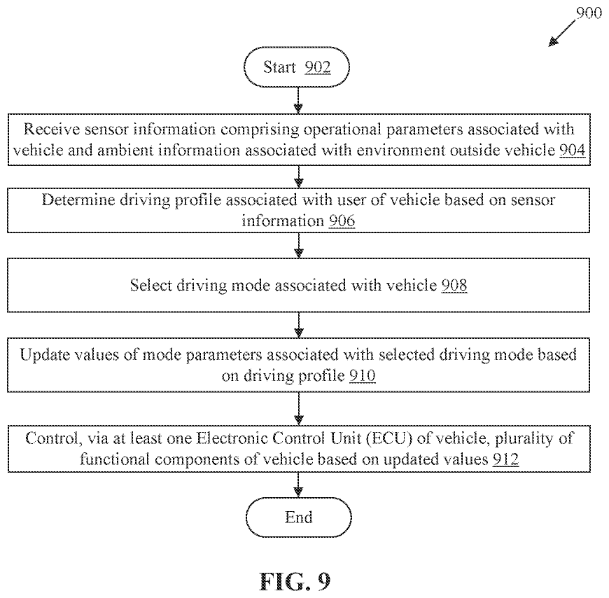

FIG. 9 is a flowchart that illustrates an exemplary method of updating values of mode parameters of a driving mode of a vehicle, in accordance with an embodiment of the disclosure. FIG. 9 is explained in conjunction with elements from FIG. 1, FIG. 2, FIG. 3, FIGS. 4A and 4B, FIG. 5, FIG. 6, FIGS. 7A and 7B, and FIGS. 8A and 8B. With reference to FIG. 9, there is shown a flowchart 900, which may depict exemplary operations that are performed by an exemplary system, such as the system 104 of FIG. 1 or any suitable system, apparatus, or device, such as the control circuitry 204. The method illustrated in the flowchart 900 may start at 902 and proceed to 904.

At 904, sensor information may be received. In one or more embodiments, the control circuitry 204 may receive the sensor information which may include operational parameters associated with the vehicle 102 and the ambient information associated with an environment outside the vehicle 102, as further described, for example, in FIG. 1, FIG. 2, and FIG. 3.

At 906, the driving profile 312 associated with a user of the vehicle 102 may be determined based on the sensor information. In one or more embodiments, the control circuitry 204 may determine the driving profile 312 associated with the user of the vehicle 102, as further described, for example, in FIG. 1, FIG. 2, and FIG. 3.

At 908, a driving mode associated with the vehicle 102 may be selected. In one or more embodiments, the control circuitry 204 may select the driving mode associated with the vehicle 102, as described, for example, in FIG. 1, FIG. 2, FIG. 3, and FIGS. 4A and 4B.

In 910, update values of mode parameters associated with the selected driving mode based on the driving profile 312. In one or more embodiments, the control circuitry 204 may update values of the mode parameters associated with the selected driving mode, as described, for example, in FIG. 1, FIG. 2, FIG. 3, and FIGS. 4A and 4B.

At 912, the plurality of functional components 106 of the vehicle 102 may be control via the at least one ECU 108 of the vehicle 102. In one or more embodiments, the control circuitry 204 may control via the at least one ECU 108 of the vehicle 102, the plurality of functional components 106 of the vehicle 102 based on updated values, as described, for example, in FIG. 1, FIG. 2, FIG. 3, and FIGS. 4A and 4B. Control may pass to end.

Although the flowchart 900 is illustrated as discrete operations, such as 902, 904, 906, 908, 910, and 912, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of computer-executable instructions executable by the system 104 associated with the vehicle 102. The set of instructions may be executable by the system 104 to perform operations that may include receiving the sensor information which may include operational parameters associated with the vehicle 102 and the ambient information associated with an environment outside the vehicle 102. The operations may further include determining the driving profile 312 associated with a user of the vehicle 102 based on the sensor information and selecting a driving mode associated with the vehicle 102. The operations may further include updating values of the mode parameters associated with the selected driving mode based on the driving profile 312. The operations may further include controlling, via at least one ECU 108 of the vehicle 102, the plurality of functional components 106 of the vehicle 102 based on the updated values.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

What is claimed is:

1. A system, comprising:
control circuitry configured to:
receive sensor information comprising operational parameters associated with a vehicle and ambient information associated with an environment outside the vehicle;
determine a driving profile associated with a user of the vehicle based on the sensor information;
select a driving mode associated with the vehicle;
update values of mode parameters associated with the selected driving mode based on the driving profile; and
control, via at least one electronic control unit (ECU) of the vehicle, a plurality of functional components of the vehicle based on the updated values.

2. The system according to claim 1, wherein each of the parameters corresponds to a functional component of the plurality of functional components.

3. The system according to claim 1, wherein the plurality of functional components includes at least one of an acceleration pedal, a brake pedal, an electric power steering, a suspension system, a supplemental restraint system (SRS), or a vehicle stability assist (VSA).

4. The system according to claim 1, wherein the operational parameters associated with the vehicle comprises at least one of an acceleration pedal (AP) position of the vehicle, a master cylinder pressure associated with a brake pedal of the vehicle, a steering angle associated with an electric power steering of the vehicle, and a plurality of suspension parameters associated with a suspension system of the vehicle.

5. The system according to claim 1, wherein the ambient information associated with the environment comprises at least one of a condition of a road in an active route of the vehicle, a terrain type associated with the active route, an amount of precipitation on the road, a type of the road, a weather condition for a current location of the vehicle in the active route.

6. The system according to claim 1, wherein the driving profile comprises at least one of:
an acceleration pedal (AP) map associated with an AP component the vehicle;
a steering feedback associated with a steering component of the vehicle;
tuning information associated with a suspension component of the vehicle;
a level of regenerative braking associated with a braking component of the vehicle; and
scene detection information associated with the environment outside the vehicle.

7. The system according to claim 1, wherein the control circuitry is further configured to apply a pre-trained machine learning (ML) model on the sensor information to determine the driving profile associated with the user.

8. The system according to claim 1, wherein the control circuitry is further configured to acquire historical sensor data associated with the vehicle, and wherein the driving profile is determined further based on the historical sensor data.

9. The system according to claim 1, wherein the control circuitry is further configured to control a display device associated with the vehicle to render the selected driving mode, the mode parameters, and the updated values of mode parameters on a Graphical User Interface (GUI).

10. The system according to claim 9, wherein the GUI comprises:
a first UI element to save the updated values of mode parameters as an individual driving mode, and
a second UI element to share the individual driving mode with a vehicle that is associated with a person who is different from the user.

11. The system according to claim 9, wherein the GUI further comprises a first option to lock at least one value of the updated values of mode parameters, and wherein the control circuitry is further configured to:
receive a selection of the first option; and
ignore the update of at least one of the values of mode parameters based on the selection of the first option.

12. The system according to claim 9, wherein the GUI further comprises a prompt overlay with an option to switch to a preset driving mode that is for a weather condition or a road traffic condition, and
wherein the control circuitry is further configured to:
receive a selection of the option in the prompt overlay;
select the preset driving mode; and
control the plurality of functional components based on values of mode parameters associated with the preset driving mode.

13. The system according to claim 9, wherein the GUI further comprises a slider UI element for each of the mode parameters, and each segment of a length of the slider UI element represents a range of values associated with a type of mode for a corresponding mode parameter of the selected driving mode.

14. The system according to claim 13, wherein the update of the values corresponds to a movement of an indicator along the length of the slider UI element.

15. The system according to claim 1, wherein the control circuitry is further configured to:
detect an execution of a cruise control operation for a duration of a movement of the vehicle; and
pause the update of the values of mode parameters for the duration.

16. A method, comprising:
in a system associated with a vehicle:
receiving sensor information comprising operational parameters associated with the vehicle and ambient information associated with an environment outside the vehicle;
determining a driving profile associated with a user of the vehicle based on the sensor information;
selecting a driving mode associated with the vehicle;
updating values of mode parameters associated with the selected driving mode based on the driving profile; and
controlling, via at least one electronic control unit (ECU) of the vehicle, a plurality of functional components of the vehicle based on the updated values.

17. The method according to claim 16, wherein the driving profile comprises at least one of:
an acceleration pedal (AP) map associated with an AP component the vehicle;
a steering feedback associated with a steering component of the vehicle;
a tuning information associated with a suspension component of the vehicle;
a level of regenerative braking associated with a braking component of the vehicle; and
a scene detection information associated with the environment outside the vehicle.

18. The method according to claim 16, further comprising controlling a display device associated with the vehicle to render the selected driving mode, the mode parameters, and the updated values of mode parameters on a Graphical User Interface (GUI).

19. The method according to claim 18, wherein the GUI further comprises a slider UI element for each of the mode parameters, and each segment of a length of the slider UI element represents a range of values associated with a type of mode for a corresponding mode parameter of the selected driving mode.

20. A non-transitory computer-readable medium having stored thereon, computer-executable instructions which, when executed by a system associated with a vehicle, cause the system to execute operations, the operations comprising:
receiving sensor information comprising operational parameters associated with the vehicle and ambient information associated with an environment outside the vehicle;
determining a driving profile associated with a user of the vehicle based on the sensor information;
selecting a driving mode associated with the vehicle;
updating values of mode parameters associated with the selected driving mode based on the driving profile; and
controlling, via at least one electronic control unit (ECU) of the vehicle, a plurality of functional components of the vehicle based on the updated values.
